(19) United States
(12) Patent Application Publication
(10) Pub. No.: US 2004/0200314 A1
(43) Pub. Date: Oct. 14, 2004

(54) Bicycle crank arm

(76) Inventors: Frank Hermansen, Laguna Beach, CA (US); Carl Winefordner, Laguna Beach, CA (US)

Correspondence Address: LEONARD TACHNER, A PROFESSIONAL LAW, CORPORATION, 17961 SKY PARK CIRCLE, SUITE 38-E, IRVINE, CA, 92614

(21) Appl. No.: 10/412,397

(22) Filed: Apr. 12, 2003

(51) Int. Cl. G05G 1/14

(52) U.S. Cl. 74/594.1

(57) ABSTRACT

A hollow bicycle crank arm has a central tubular portion to reduce weight and two mounting-boss portions for mounting a crank spindle and pedal during use. A crank arm base is forged or cast with a relatively thin back and sides, preferably out of aluminum or magnesium. The crank arm base has a generally C-shaped cross section. An arm cover has a top and sides and is made from stamped steel or titanium. The cover is placed over the open crank arm base to enclose a significant hollow section. The stamped arm cover does not require any threading or welding. It can be made using a very inexpensive stamping process. The crank arm can be made using relatively inexpensive traditional manufacturing processes such as die casting or forging.

### BACKGROUND OF THE INVENTION

1. Field of the Invention

The present invention relates generally to structural components subjected to flexural and torsional loads, and more specifically, to a bicycle crank arm of improved strength-to-weight ratio and reliability.

2. Background Art

Many methods have been used to try to create a lighter and stiffer crank set. The rider transfers power through the pedals, which are screwed into the crank arms. The force from the rider's legs causes the crank arms to be placed under bending as well as twisting loads. A transverse shear (beam shear) force also results from the pedaling force. Because it is laterally offset from the arm, the pedaling force also tends to twist the arm about it long axis. The applied bending moment varies from near-zero at the pedal to a maximum value at the crank spindle. This can cause reliability problems for any joints or welds that are near the crank spindle.

For stiffness, the ideal crank arm cross section has a large moment of inertia. In order to create a large moment of inertia in a weight efficient manner, the crank arms usually either have an I-beam cross section, a C-shaped cross section, or a tubular cross section. The I-beam and C-shaped cross sections are usually created either by forging, or die casting, or CNC machining, or a combination of these processes. Tubular cross sections are superior to I-beam and C-shaped cross sections for stiffness to weight ratio. Tubular cross sections are made either by a proprietary process that retains a hollow center during forging or casting, or by welding two shells together, or by welding a tube to end components.

There have been various attempts to economically produce an optimal hollow crank arm. All of these processes to make tubular cross sections are relatively expensive. The proprietary processes require expensive research and development, expensive proprietary equipment, and careful process control. Also, there are limits to how carefully the hollow area can be controlled, so there are limits to how efficient the crank can be designed. Welding two shells together is a labor intensive process, and for aesthetics, usually requires expensive post finishing work to hide the aesthetics of the weld. Welding a tube of steel or titanium or aluminum to end components is expensive because it requires carefully fixturing and welding many components together (i.e.: welding the tube to a threaded boss and end cap on one end, and welding the other end of the tube to a spider assembly). Welding can also decrease the strength of the material near the weld.

The transitions from the solid end portions to the tubular portion of existing crank arms are often abrupt and with sharp edges or corners. Sharp edges, corners, abrupt changes in material thickness and other geometric discontinuities induce stress concentrations. Stress concentrations significantly increase stress levels over nominal values, requiring extra material thickness to ensure reliability.

Most mid to higher performance cranks are made of forged or cast aluminum, or are CNC machined. Some extremely expensive high performance cranks are made of thin-walled welded tubular chromoly, steel or titanium. In rare instances, carbon fiber is used, usually either to reinforce aluminum, or with metal inserts. Aluminum is a cost effective material to use for crank arms because it is so easily forged or cast. However, aluminum has some disadvantages as a material for crank arms. For example, aluminum is a low density metal that is susceptible to damage from impacts with rocks and such, common during mountain biking. Aluminum has poor fatigue resistance compared to steel and titanium, and aluminum is difficult to forge or cast with a hollow interior. CNC machining is expensive because it requires a relatively expensive CNC mill, a relatively skilled programmer, it wastes a significant amount of material, it is a relatively slow process, and the surface finish is rough. Carbon fiber (and similar) is very expensive because the materials are expensive, and the process is slow and difficult and requires highly skilled workers.

All existing cranks that have steel or titanium crank arms, require welding. Welding can be expensive and can weaken the material in the vicinity of the weld. Higher end crank arms (whether solid aluminum or hollow) typically require extensive finishing (polishing or CNC work) for aesthetic reasons and this adds substantially to the cost.

All existing crank arms use, at most, a single type of metal. Sometimes the spider (the chain ring holding structure) is made of a different material than the crank arms, but the arms are always made using only a single type of metal. The only two-material crank arms involve resin impregnated fibers (such as carbon fiber) that reinforce the metal.

U.S. Pat. No. 4,811,626 to Bezin teaches a hollow crank arm comprised of three components: a tube and two end-lugs. The end-lugs have protrusions that fit within the tube, ready for bonding or welding. The end-lugs are solid to absorb concentrated loads from a crank spindle and pedal. In order to achieve a lightweight assembly, the tube is of thin-wall section or made from fiber composite material. The crank arm has at least one joint proximate to a region of maximum bending moment, where the crank arm mounts to the spindle shaft. Locating a joint near a region of maximum bending moment increases the likelihood of failure unless additional material thickness is provided. Bezin's crank arm also suffers from an abrupt transition where the thin tube meets the solid lug, producing a stress concentration. There is no provision for optimizing the configuration of the components to reduce the stress concentration. If the crank arm is fabricated using a welding process, it is difficult to obtain proper weld penetration in the heavy lug without overheating the thin tube. Instead, it would be preferable to weld metals of similar thickness. It also uses only a single material such as aluminum.

U.S. Pat. No. 5,179,873 to Girvin teaches a crank arm comprised of four components: A tube, two end-lugs and a plate-like redundant doubler, which is used to reinforce a weld proximate to a region of maximum bending moment. Girvin discusses configuring the redundant doubler plate to reduce stress concentration at the upper welded interface, but does not address the abrupt transition where the tube otherwise meets the lug. Girvin discusses using a tapered tube to increase the section modulus in regions of high stress, but does not provide for a varying wall thickness. Girvin states that his crank arm is to be made from high strength 4130 steel, permitting a very thin tube to reduce weight. Girvin does not address the issue of satisfactorily welding a thin-wall tube to a more massive lug. Girvin provides no way to adapt to lightweight alloys. Girvin states that the doubler is used to safeguard against tensile failure at the weld. A Girvin crank arm made from a lightweight, low-modulus metal, such as aluminum alloy, could be expected to experience localized, Brazier-type compressive buckling failure prior to any tensile rupture failure in the tube. If Girvin's crank arm were feasible in lightweight alloy, it would not be necessary to specify heavy steel as the preferred material to create a lightweight bicycle component. It would be preferable to provide a crank arm that could be readily adapted to a wide range of materials and did not require redundant doubling of material to compensate for inherently weak joints proximate to a region of maximum bending moment. Girvin uses only a single material such as steel.

U.S. Pat. Nos. 5,819,599; 5,819,600 and 5,845,543 to Yamanaka depict a hollow crank arm comprised of two parts: A forged crank arm with a central, longitudinal groove and a long cap that is welded over the groove to form a box-beam. The welded surfaces are substantially parallel to the long axis of the crank arm, which results in a relatively large weld area, long processing time and high fabrication expense. The sharp interior corners and abrupt changes in wall thickness cause stress concentrations. There is relatively little space enclosed by the box-beam, owing to the relatively thick walls, which results in a heavy, stiff and rigid crank arm. Yamanaka discusses shaping the long axis of the groove into a “ship hull shape” to better distribute the stresses in the crank arm, but provides no other means of optimizing the crank arm. Yamanaka's patents assert a novel means of mounting a crank spindle to a crank arm, with no discussion of adapting, modifying or improving the hollow crank arm depicted. Yamanaka uses only a single material such as aluminum.

U.S. Pat. No. 6,068,803 to Yamanaka depicts a hollow crank arm made by first making a mold core. The mold core is made on a mold core mold. In this embodiment, the mold core mold is made from silicone rubber and it is made in a mold that splits in two. On the inside of the mold core mold is formed a space that corresponds to the cavity mold core and a space that corresponds to a mold core holder. Mold core sand whose surface has been coated with a resin is poured into these spaces. The mold core sand is tamped down at a specific pressure, after which it is put into a baking furnace along with the mold core mold, where it is heated to the hardening temperature of the resin. This heating thermosets the resin coating on the surface of the mold core sand, hardens the mold core sand within the mold core mold and creates the mold core. Once the mold core has hardened, the mold core mold is split open and the mold core is taken out from the spaces. After being taken out, the mold core retains its hardened shape and does not readily crumble under light force. The melt space is formed within a metal mold and the mold core is positioned within the melt space. In order for the mold core to be accurately positioned within the melt space, spacers made from foamed styrene or the like are used to position the mold core. The melt space communicates with a sprue via a runner. A molten aluminum alloy is then poured into the sprue, goes through the runner and enters the melt space. This casting method is called a metal mold gravity casting, in which ordinary casting is performed using only gravitational pressure. The aluminum casting is removed from the mold and the mold core holder is cut off and the lower hole in the pedal attachment hole is made with a drill. Since this machining permits the exterior of the crank arm to communicate with the mold core, the mold core sand can be taken out from the opening. After this, the casting is finished to the required crank shape by cutting, grinding, polishing, or other such machining. Yamanaka's crank arm, however, requires a relatively expensive and complex manufacturing process and has limited control over the wall sections (and thus the maximum size and shape of the hollow cavity). For example, the single-use cores would be expensive and time consuming to make. It also uses only a single material such as aluminum.

U.S. Pat. No. 6,195,894 to Mizobe et al depicts a hollow bicycle crank that can be manufactured by casting. In one embodiment, a crank arm for a bicycle includes a crank arm body having a pedal attachment hole on a first end thereof and a spindle attachment hole on a second end thereof. The crank arm body defines an elongated interior cavity surrounded by a shell, wherein the interior cavity is open to an exterior of the crank arm body. The opening can be used to access the cavity during and after manufacturing. The cavity may be filled with a material having a lower specific gravity than the metal forming the crank arm to provide strength while still saving weight. Mizobe's crank arm, however, requires a relatively expensive and complex manufacturing process, has limited control over the wall sections (and thus the maximum size and shape of the hollow cavity), and has the added weight of an internal filler. In another embodiment, the internal filler is a sand-like material that is positioned into a casting mold so that a melt space is formed around the mold core, molten metal is poured into the casting mold and the molten metal is solidified to form a crank billet. The filler material may be removed through an opening in the crank billet. This may be accomplished by drilling the crank billet to form the pedal attachment hole in a location that communicates with the filler material and then removing filler material through the pedal attachment hole. This embodiment suffers the same disadvantages as the first embodiment except for the lack of filler material weight and requires the additional step of removing the filler material. It also uses only a single material such as aluminum.

U.S. Pat. No. 5,979,923 to Chiang depicts a bicycle crank arm which is formed of a hollow crank body, a head portion fastened to one end of the hollow crank body and a pedal hole portion fastened to other end of the hollow crank body. The head portion and the pedal hole portion are fastened with the hollow crank body by soldering and riveting. Chiang describes in his U.S. Pat. No. 6,508,002 that such a prior art bicycle crank arm as described in his '923 patent is neither cost-effective nor durable in view of the fact that the process of fastening the head portion and the pedal hole portion with the hollow crank body is rather time-consuming and that the head portion and the pedal hole portion are apt to break away from the hollow crank body. It also uses only a single material such as aluminum or steel.

U.S. Pat. No. 6,508,002 to Chiang depicts a bicycle crank arm which is made integrally and is provided with an elongated cavity that is open on one end by a forging process. This product is then processed by rollers such that the open portion is narrowed. Thereafter, the product is processed in a molding tool under heat and pressure such that the portion is curved and that curved portion has a predetermined radian. Finally, the product is processed in a cold forging mold to become a bicycle crank arm. Chiang's crank arm, however, requires a relatively expensive and complex manufacturing process and has limited control over the wall sections (and thus the maximum size and shape of the hollow cavity). It also uses only a single material such as aluminum.

It would be desirable to provide a hollow crank arm that is largely free of stress concentrations, has relatively thin walls in the tubular portion, encloses a relatively large volume of space to reduce weight, comprises no welds and may be readily designed and fabricated in the most efficient configuration for an optimal degree of flexibility.

### OBJECTS OF THE PRESENT INVENTION

It is an object of the present invention to provide a bicycle crank arm with a high strength to weight ratio.

It is another object of the present invention to provide a bicycle crank arm that is relatively simple and inexpensive to make.

It is another object of the present invention to provide a bicycle crank arm that is relatively easy to produce in large quantities.

It is another object of the present invention to provide a bicycle crank arm that can use two or more different materials to take advantage of the different material properties.

It is another object of the present invention to provide a bicycle crank arm that a consumer could upgrade by changing the cover, for example, easily changing the cover from steel to titanium.

It is another object of the present invention to provide a bicycle crank arm that allows higher and lower end versions to share some of the same components in order to reduce inventory.

It is another object of the present invention to provide a bicycle crank arm that has color options.

It is another object of the present invention to provide a bicycle crank arm that has a unique and aesthetically pleasing look.

It is another object of the present invention to provide a bicycle crank arm that can be designed to work with standard bottom brackets.

It is another object of the present invention to provide a bicycle crank arm that can use a soft metal such as aluminum that is protected from damage by a hard metal cover such as steel or titanium.

It is another object of the present invention to provide a bicycle crank arm that is less likely to encounter catastrophic failure.

It is another object of the present invention to provide a bicycle crank arm that requires relatively little finishing (extensive polishing and such).

It is another object of the present invention to provide a bicycle crank arm that allows use of titanium or steel without welding.

It is another object of the present invention to provide a bicycle crank that is largely free of stress concentrations and thus highly resistant to fatigue-type failure.

It is another object of the present invention to provide a bicycle crank arm that has a replaceable threaded fitting that fits the pedal.

It is another object of the present invention to provide an alternative embodiment of a bicycle crank arm that has an integrated bottom bracket.

It is another object of the present invention to provide an alternative embodiment of a bicycle crank arm that has a solid arm made of softer material such as aluminum with a cover made of a harder material such as steel.

### SUMMARY OF THE INVENTION

A hollow bicycle crank arm has a central tubular portion to reduce weight and two mounting-boss portions for mounting a crank spindle and pedal. A crank arm base is forged or cast with a relatively thin back and sides, preferably out of aluminum or magnesium. The crank arm base has a generally C-shaped cross section. An arm cover has a top and sides and is made from stamped steel or titanium. The cover is placed over the open crank arm base to enclose a significant hollow section. The stamped arm cover does not require any threading or welding. It can be made using a very inexpensive stamping process. The crank arm can be made using relatively inexpensive traditional manufacturing processes such as die casting or forging.

The bicycle crank arm is assembled from an arm base, an arm cover, and fittings that secure the cover to the arm base. The arm base has a large recess that becomes the hollow portion after assembly. The arm base is preferably made by either die casting or forging out of a material such as aluminum or magnesium and has smooth transitions from thick to thin wall sections. The arm cover is preferably stamped out of a thin sheet of steel or titanium and fits closely over the arm base, enclosing the arm recess, forming a hollow space therein. The fit between the crank arm base and the arm cover is, ideally, a close fit, because this will give more strength and stiffness. The stamped arm cover does not require any threading or welding. It can be made using a very inexpensive stamping process. A threaded fitting secures the arm cover to the arm base on the spindle end of the crank arm. The arm base is keyed to the crank spindle via a tapered spline. A screw secures the arm base to the crank spindle. The pedal end of the arm cover and arm base are secured by a threaded fitting that is press fit into a flanged fitting. The threaded fitting has a thread for attaching the pedal and can be easily replaced, in case the threads become damaged. Alternatively, the pedal could be used to secure the arm cover to the arm base on the pedal end of the crank arm. The drive side arm base has legs with holes for attaching chain rings. The non-drive side arm base does not have chain rings and so does not have legs.

To demonstrate how effective the above configuration is, one can take a typical cardboard shoe box and flex it in a twisting motion without the lid. The box will feel flimsy and weak. If the lid (that has a folded lip all around) is placed over the recess opening of the box, the box will feel perhaps ten times stiffer. If the lid is instead placed on the bottom of the box, then the box will not be noticeably stiffer than without the lid. Thus, it is by closing the box to enclose the hollow space that the box becomes substantially stiffer. It is important to note that this substantial increase in stiffness occurs even if the lid is only held to the box at the two ends of the box. In other words, it is not necessary to bond the lid's folded lip all around the box in order to gain the majority of the stiffness increase.

A thin sheet of steel or titanium would be flimsy, but by stamping the part so that the edges are formed over all the way around, the stiffness is significantly higher. Then, by fitting this part over the open crank arm, the stiffness is higher still.

The crank arm described herein is economical to manufacture. Die casting or forging the arm base from aluminum or magnesium is an efficient, standardized method of manufacturing. This is the same method of manufacture used on typical low cost solid aluminum crank arms. The post machining required is also the same as for typical low cost solid aluminum crank arms. Therefore, the arm base portion of this invention will require the same processes as typical low cost solid aluminum crank arms. The arm cover is made by a stamping process and does not require any welding or post machining. Stamping in this manner is extremely efficient and inexpensive and can provide parts that have such good surface finishes that they do not require expensive polishing. In fact, titanium and certain grades of stainless steel would not even require any plating or finishing treatments. Stamping is also a rapid process that can produce thousands of parts per hour. The crank arm described herein will have very high performance, yet will cost less to manufacture than other high performance crank arms.

The crank arm described herein is more resistant to abrasive damage. The steel or titanium arm cover not only significantly strengthens the arm base, it also protects the arm base from damage that can be caused by impacts with rocks and during crashes. Steel and titanium are significantly harder than aluminum and magnesium and much more resistant to abrasion and impact.

The crank arm described herein allows flexible inventory for multiple versions of the crank. For example, three different crank models could share the same aluminum arm base, but one model could use a chromoly arm cover, a second model could use a stainless steel arm cover and a third model could use a titanium arm cover. This versatility also allows the factory to gain efficiencies of manufacture that come with higher volumes (for the arm base) and allows a consumer to upgrade existing crank arms with improved arm covers.

Certain finishes can be applied only on particular materials. For example, forged aluminum can be anodized in various different colors, whereas steel and titanium cannot be anodized. Anodized aluminum looks noticeably different from steel or titanium, regardless of finish treatment. Because the crank described herein ideally uses different materials for the arm base and arm cover, it is possible to create a unique and pleasing look.

The crank arm described herein can be designed to fit a standard bottom bracket, or it can be designed to include an integrated bottom bracket. Nothing about the inventive design hinders these possibilities.

The crank arm described herein can be designed with solid arms made of a relatively soft material such as aluminum or magnesium and have a cover made of a relatively hard material such as steel or titanium. While this configuration would have a lower stiffness to weight ratio than a hollow centered crank arm, it is still stronger. Compared to traditional crank arms, this configuration still has the advantage of having a cover made of a relatively hard material that protects the relatively soft base material. Also, the hard cover still significantly strengthens and stiffens the arm compared to prior art crank arms of similar dimensions. Also, this configuration could still have some of the other advantages described above such as an easily replaceable threaded pedal fitting. This embodiment could be ideal for certain bicycling applications such as downhill racing, where strength is more important that weight.

The crank arm described herein is more resistant to catastrophic failure. Different materials have different fatigue failure properties. Because the crank described herein ideally uses two different materials for the arm base and the arm cover, it is extremely unlikely that both would fail simultaneously. Additionally, because there is no welding required, there is no loss of physical properties that can be caused by excessive heat. Also, the smooth transitions from thick to thin wall sections reduce stress concentrations. A crank arm that is largely free of stress concentrations may have reduced material thickness and weight without any substantial reduction in strength or reliability.

While it is preferred to make the crank arm using a relatively soft material such as aluminum or magnesium for the arm base and a relatively hard material for the arm cover such as steel or titanium, there are still significant advantages over the prior art to making both components out of the same or similar material such as aluminum. The advantages include ease of manufacturing, a good stiffness to weight ratio, different finishes for the arm cover and arm base for aesthetic appeal and easy to upgrade to a stiffer arm cover. An arm cover made of aluminum or magnesium could be made by several methods including stamping, die casting, forging.

While it is preferred because of cost and manufacturing speed to make the arm cover out of steel or titanium, it is possible to use resin-impregnated carbon fiber and other resin-impregnated fibers to produce a strong and light arm cover. The process for making a component using resin-impregnated fibers is called “fiber wrapping”.

While it is preferred because of cost and manufacturing speed to make the arm base by die casting or forging, it can also be made by machining such as CNC machining.

While it is preferred to use fittings on the pedal end of the crank arms to hold the arm cover onto the arm base, it is not necessary. If the arm base is threaded, then the pedal would secure the arm cover to the arm base when the pedal is screwed onto the arm base.

Using the technology described herein, there are variety of other configurations that are feasible for the arm base and cover. The cover side walls could nest inside the base side walls instead of outside. The base could be configured to have top and side walls instead of bottom and side walls and the cover having a back wall and side walls such that the cover fits on the inboard side of the base. As used herein the terms “aluminum”, “magnesium”, “steel” and “titanium”, also include alloys thereof.

### BRIEF DESCRIPTION OF THE DRAWINGS

The aforementioned objects and advantages of the present invention, as well as additional objects and advantages thereof will be more fully understood hereinafter, as a result of a detailed description of preferred embodiments thereof, when taken in conjunction with the following drawings in which:

FIG. 1 is an exploded view of a preferred embodiment of the bicycle crank of the present invention;

FIG. 2 is a perspective view of the bicycle crank of FIG. 1;

FIG. 3 is a front view of the partial bicycle crank with a pedal attached;

FIG. 4 is a cross sectional view taken through the bottom bracket of the bicycle crank rotated 90 degrees from the bicycle crank shown in FIG. 3;

FIG. 5 is a cross sectional view taken through the non-drive side crank arm and pedal of the bicycle crank shown in FIG. 3;

FIG. 6 is a cross sectional view taken through the non-drive side arm of the bicycle crank shown in FIG. 3;

FIG. 7 is a side view of the non-drive side crank arm;

FIG. 8 is a cross sectional view of the non-drive side crank arm shown in FIG. 7;

FIG. 9 is a side view of an alternative embodiment of the non-drive side crank arm;

FIG. 10 is a cross sectional view of the alternative embodiment of the non-drive side crank arm shown in FIG. 9; and

FIG. 11 is an exploded view of another alternative embodiment bicycle crank.

### DETAILED DESCRIPTION OF PREFERRED EMBODIMENT

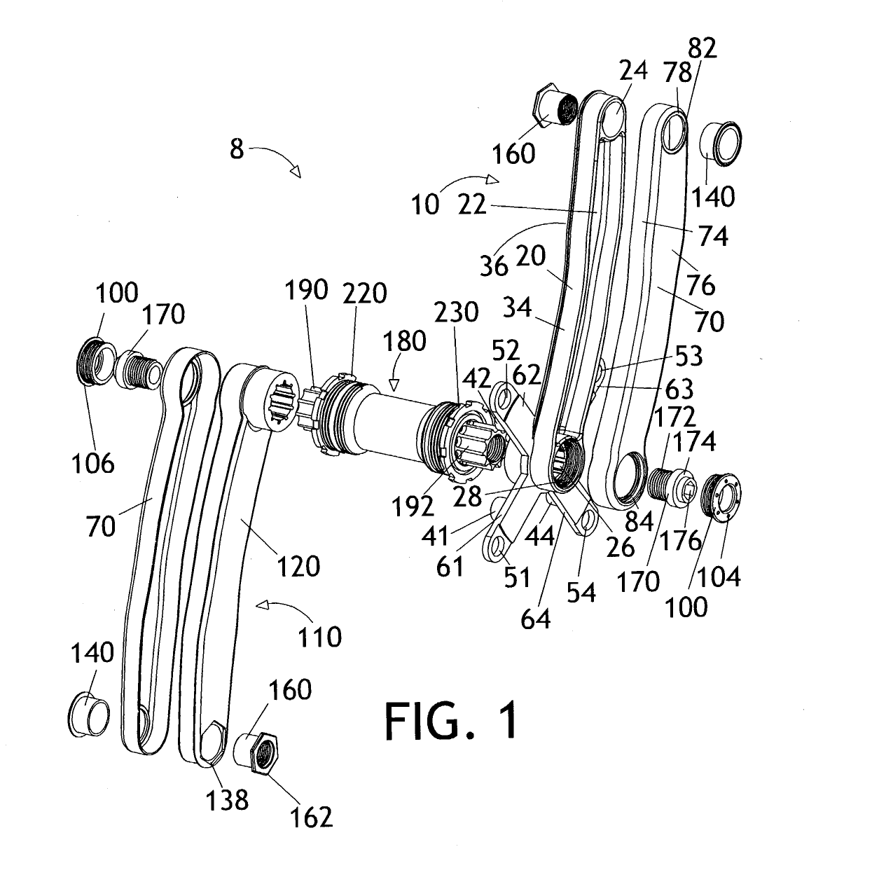

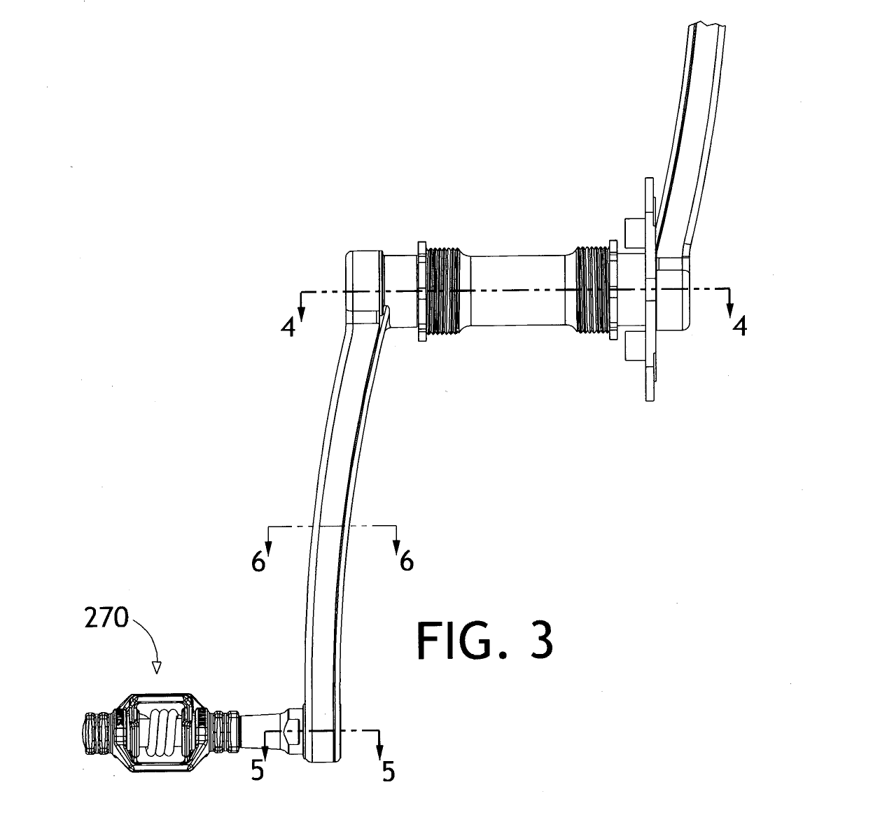

The preferred embodiment of the present invention may be understood by referring to FIGS. 1-8. It will be seen that a bicycle crank 8 comprises a drive side crank arm 10, a conventional bottom bracket 180 and a non-drive side crank arm 110. The drive side crank arm 10 comprises a base 20, a cover 70, fittings 100, 140 and 160 and screw 170. The typical bottom bracket 180 comprises a spindle 190, a body 220, a ring 230 and bearings 240. The non-drive side crank arm 110 is comprised of a base 120, a cover 70, fittings 100, 140, and 160 and a screw 170. Bases 20 and 120 are preferably made by die casting or forging out of aluminum or magnesium and has a side wall 34 and a back wall 36, to form recess 22. Cover 70 is preferably stamped out of steel or titanium and has a side wall 74 and top wall 76. When cover 70 is placed over base 20, recess 22 becomes a hollow space 202 (see FIG. 8). Cover 70 is held firmly to base 20 on one end by fittings 140 and 160 and on the other end by fitting 100 which is threaded into thread 28. Fitting 160 has a thread 164 for receiving a bicycle pedal 270 (see FIG. 3). Base 20 has a tapered spline 26 that fits over tapered spline 192 of spindle 190. Screw 170 secures base 20 to spindle 190. Base 20 has a structure for mounting chain rings (not shown), as is common in the prior art. Non-drive side crank arm 110 is identical to drive side crank arm 10 except that base 120 does not have legs 61, 62, 63, and 64 for attaching chain rings.

FIG. 1 is an exploded view of the bicycle crank 8, which comprises a drive side crank arm 10, a typical bottom bracket 180 and a non-drive side crank arm 110. The drive side crank arm 10 comprises base 20, cover 70, fittings 100, 140, and 160 and screw 170. The typical bottom bracket 180 comprises spindle 190, a body 220, and a ring 230. The non-drive side crank arm 110 comprises base 120, cover 70, fittings 100, 140, and 160, and screw 170. Bases 20 and 120 are preferably made by die casting or forging out of aluminum or magnesium and have a side wall 34 and a back wall 36, to form recess 22. Covers 70 are preferably stamped out of steel or titanium and have a side wall 74 and top wall 76. Cover 70 is held firmly to base 20 on one end by fitting 140 being press fit through cover 70, hole 82, hole 24 and base 20 and over fitting 160. Cover 70 is held firmly to base 20 on the other end by fitting 100 being threaded through cover 70, hole 84 and into thread 28 of base 20. Fitting 100 is turned using a tool that fits into recesses 104. Base 20 has a tapered spline 26 that fits over tapered spline 192 of spindle 190. Screw 170 is turned by hex 176 and secures base 20 to spindle 190. Fitting 100 not only secures one end of cover 70 to base 20, it also serves as a stop so that when screw 170 is unscrewed, drive side crank arm 10 is extracted from spindle 190, because surface 174 pushes against surface 106. Base 20 has legs 61, 62, 63, and 64 with threaded bosses 41, 42, 43 (hidden), and 44 for mounting a small chain ring (not shown), and holes 51, 52, 53, and 54 for mounting medium and large chain rings (not shown), as is common in the prior art. Non-drive side crank arm 110 is identical to drive side crank arm 10 except that base 120 does not have legs 61, 62, 63, and 64 for attaching chain rings. Hex flange 162 of fitting 160 keys into hex recess 138 of base 20 to prevent fitting 160 from rotating.

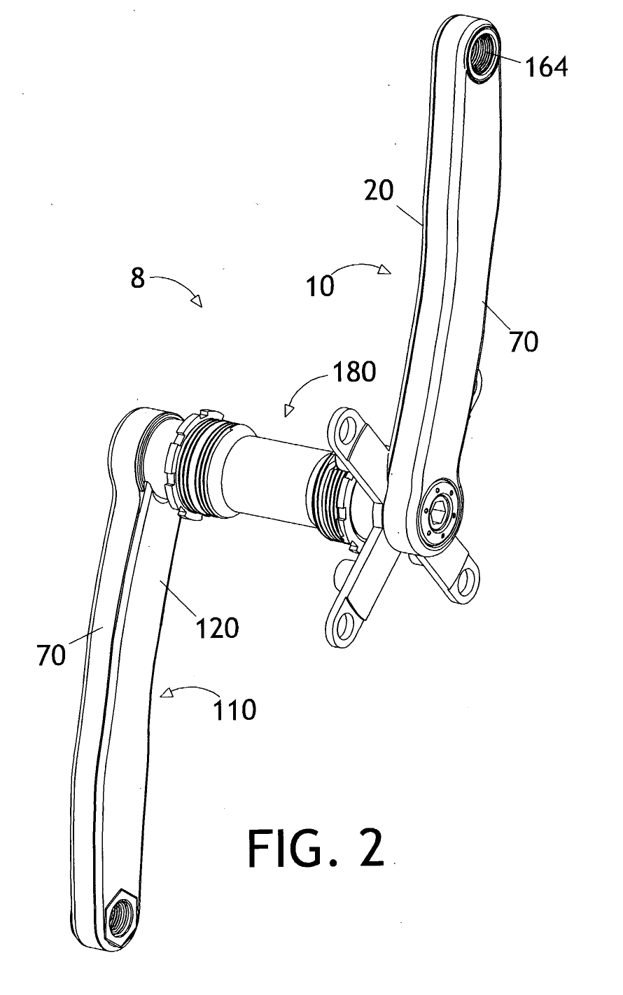

FIG. 2 is a perspective view of the bicycle crank 8, which comprises a drive side crank arm 10, a typical bottom bracket 180 and a non-drive side crank arm 110. The drive side crank arm 10 includes a base 20 and a cover 70. The non-drive side crank arm 110 includes a base 120 and a cover 70. Fitting 160 has a thread 164 for receiving a bicycle pedal 270 (shown in FIG. 3).

FIG. 3 is a front view of the partial bicycle crank 8 with a pedal 270 attached.

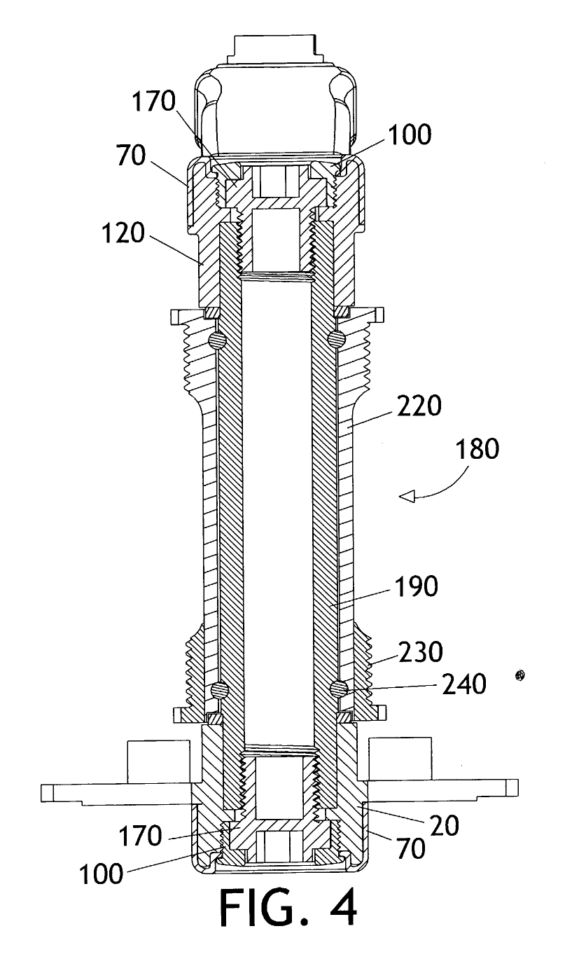

FIG. 4 is a cross sectional view taken through bottom bracket 180 of the bicycle crank 8 rotated 90 degrees from the bicycle crank shown in FIG. 3. The typical bottom bracket 180 comprises a spindle 190, a body 220, a ring 230 and bearings 240. Bases 20 and 120 are firmly attached to spindle 190 by screws 170. Covers 70 are firmly attached to bases 20 and 120 by fittings 100.

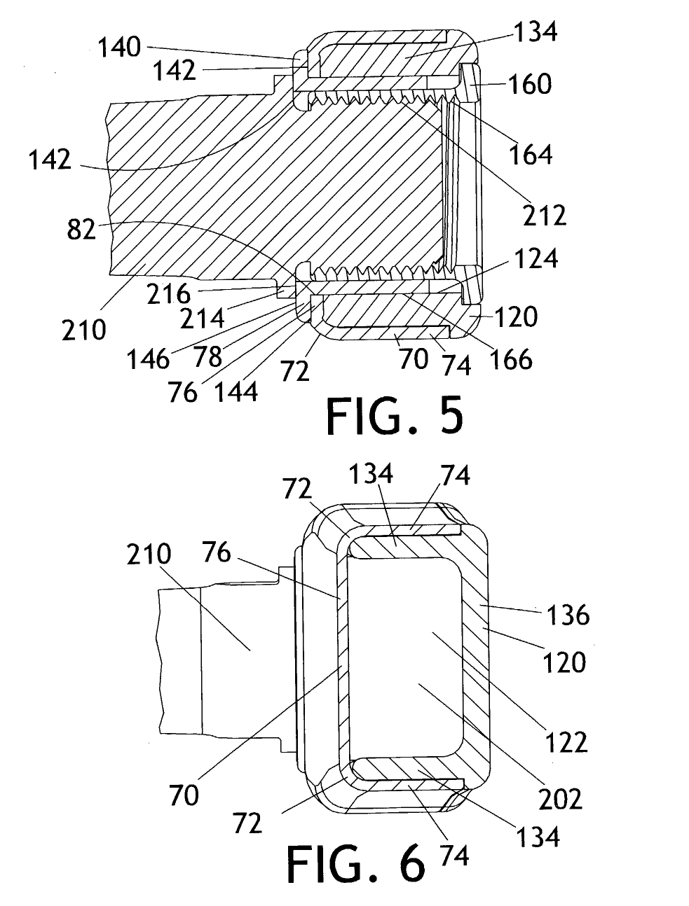

FIG. 5 is a cross sectional view taken through the non-drive side crank arm 110 and pedal 270 of the bicycle crank 8 shown in FIG. 3. Cover 70 has a top wall 76, a bend 72 and a side wall 74. Side wall 74 of cover 70 closely fits against side wall 134 of base 120. Fitting 140 passes through hole 82 of cover 70 and tightly fits into hole 124 of base 120. Fitting 160 surface 166 is press fit into hole 142 of fitting 140. Thread 212 of spindle 210 screws into thread 164 of fitting 160. Surface 216 of flange 214 firmly pushes against surface 146 of fitting 140, which causes surface 144 of fitting to push firmly against surface 78 of cover 70 and which tightly secures cover 70 to base 120.

FIG. 6 is a cross sectional view taken through the non-drive side arm 110 of the bicycle crank 8 shown in FIG. 3. Base 120 has a back wall 136 and side walls 134. Cover 70 has a top wall 76 with bends 72 and side walls 74. Top wall 76 encloses recess 122 of base 120 to become hollow space 202. In the background is spindle 210 of pedal 270.

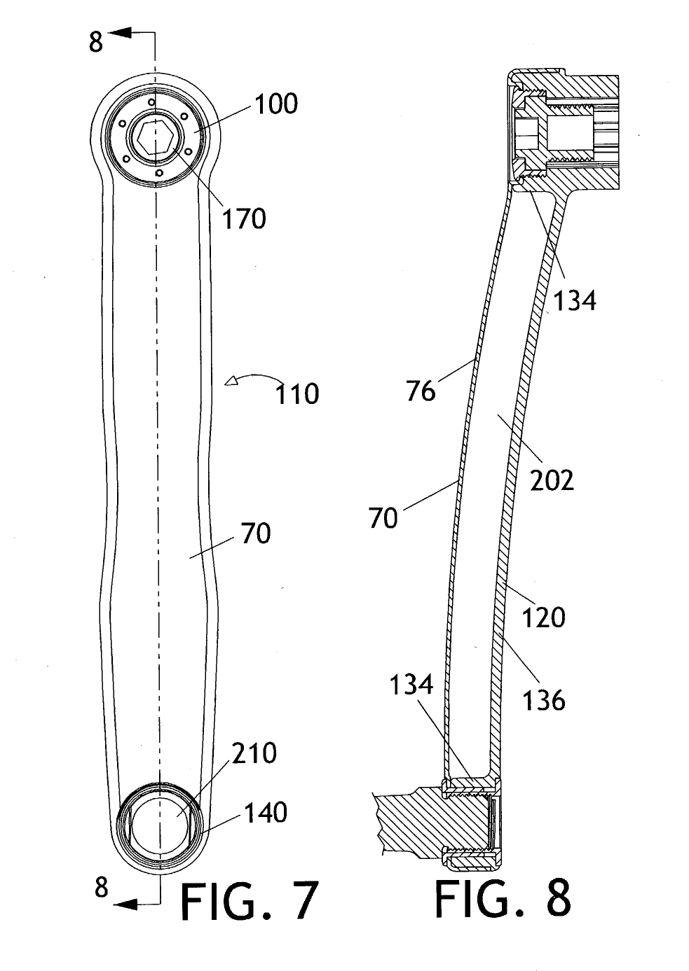

FIG. 7 is a side view of the non-drive side crank arm 110. The visible components include cover 70, fittings 100 and 140, screw 170 and spindle 210. For clarity, only spindle 210 of pedal 270 is shown.

FIG. 8 is a cross sectional view of the non-drive side crank arm 110 shown in FIG. 7. Hollow space 202 is formed between base 120 back wall 136 side walls 134 and top wall 76 of cover 70.

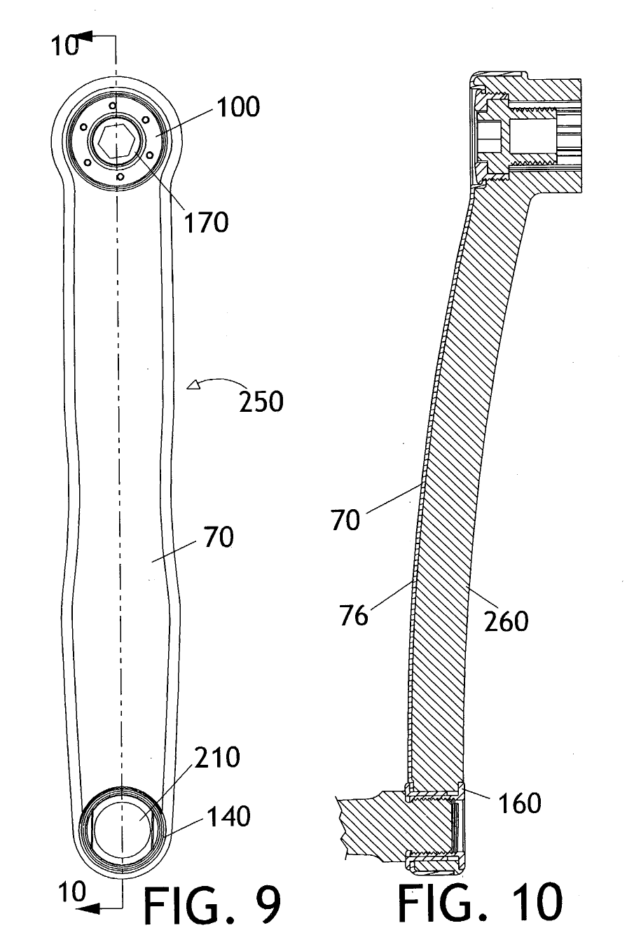

FIG. 9 is a side view of an alternative embodiment of the non-drive side crank arm 250. The visible components include cover 70, fittings 100 and 140, screw 170 and spindle 210. For clarity, only spindle 210 of pedal 270 is shown.

FIG. 10 is a cross sectional view of the alternative embodiment of the non-drive side crank arm 250 shown in FIG. 9. Base 260 is solid (does not have a hollow space). Cover 70 top wall 76 directly fits against base 260. While this embodiment would have a lower stiffness to weight ratio than non-drive side crank arm 110, it is stronger than arm 110. Compared to traditional crank arms, arm 250 still has the advantage of having cover 70 made of a relatively hard material such as steel or titanium that protects the relatively soft base 260 material such as aluminum. Also, cover 70 still significantly strengthens and stiffens arm 250 compared to prior art crank arms of similar dimensions. Also, arm 250 has the advantage of an easily replaceable fitting 160. Arm 250 has the same aesthetic advantages as the preferred embodiment. This embodiment could be ideal for certain bicycling applications such as downhill racing, where strength is more important that weight. While FIGS. 9 and 10 show only a non-drive side crank arm, the same type of configuration (a solid arm) could be used for the drive side crank arm.

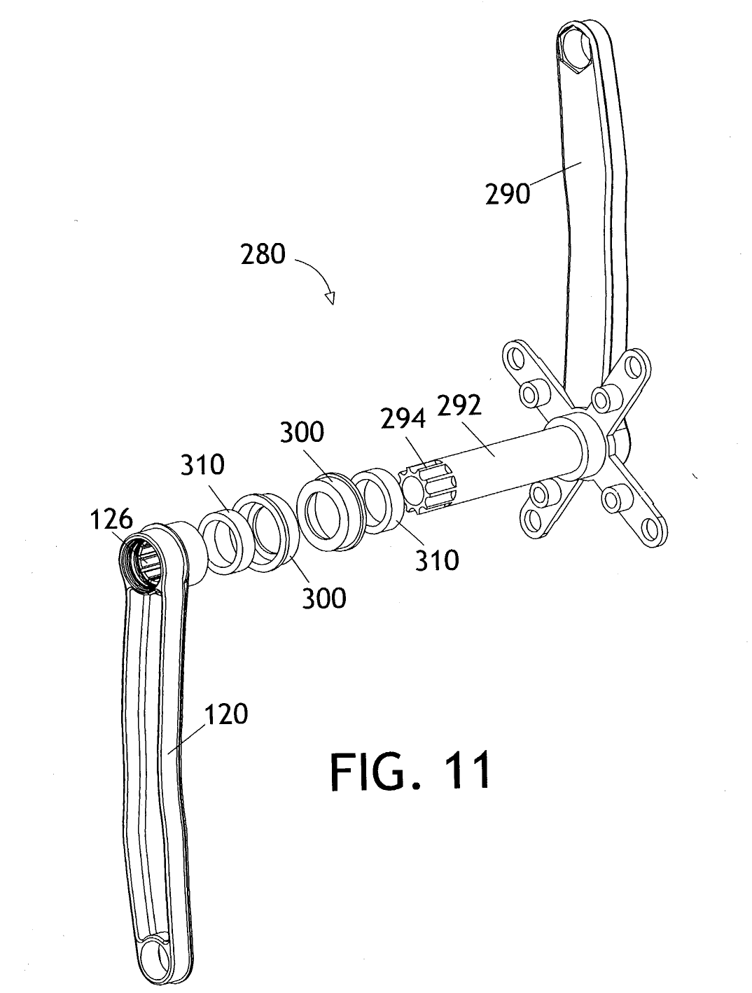

FIG. 11 is an exploded view of the alternative embodiment bicycle crank 280 with an integrated bottom bracket. The covers, fittings, and screws are not shown for clarity, but are the same as described above for the preferred embodiment. Base 290 has a spindle 292 either formed as part of the base, or made as a separate part that has been press fit into the base. Spindle 292 has a tapered spline 294 that fits tapered spline 126 of base 120. Cups 300 press fit or thread into the bicycle frame bottom bracket housing and cartridge bearings 310 fit into the cups 300. Integrated bottom brackets are well known in the prior art and offer certain advantages such as lighter weight.

Having thus disclosed certain exemplary and illustrative embodiments of the invention, it will now be apparent that various modifications and additions may be made thereto. Thus, it will be understood that the invention herein is not necessarily limited to the described specific embodiments, but only by the appended claims and their equivalents.

We claim:

1. A bicycle crank arm comprising:
an arm base having a hollow recess; and
an arm cover secured to said base over said recess to form a hollow crank arm.

2. The bicycle crank arm recited in claim 1 wherein said arm base and said arm cover are made of two different materials.

3. The bicycle crank arm recited in claim 1 wherein said arm base is made of a first material and said arm cover is made of a second material.

4. The bicycle crank arm recited in claim 3 wherein said first material is taken from the group of materials consisting of aluminum and magnesium and alloys thereof.

5. The bicycle crank arm recited in claim 3 wherein said second material is taken from the group of materials consisting of steel and titanium and alloys thereof and resin-impregnated fibers.

6. The bicycle crank arm recited in claim 1 wherein said arm base is made in a process taken from the group of processes consisting of die casting, forging and machining.

7. The bicycle crank arm recited in claim 1 wherein said arm cover is made in a process taken from the group of processes consisting of stamping, die casting, forging, machining and fiber wrapping.

8. The bicycle crank arm recited in claim 1 wherein said arm cover is made of a material that is harder than is the material of which said arm base is made.

9. A bicycle crank arm comprising:
an arm base; and
an arm cover;
the base and cover being made of different materials.

10. A bicycle crank arm comprising:
an arm base; and
an arm cover;
the base and cover being made by respectively different processes.

11. A bicycle crank arm comprising:
an arm base; and
an arm cover;
said base and cover being affixed to one another by a pedal thread insert.

12. The bicycle crank arm recited in claim 11 wherein said pedal thread insert is removable from said base and cover.

13. A bicycle crank arm comprising:
an elongated arm member having a first end for connection to a pedal and a second end for connection to a bottom bracket; and
a pedal thread insert insertable into said first end of said arm member and selectably removable therefrom for replacement thereof.
